(19) United States
(12) Patent Application Publication
(10) Pub. No.: US 2019/0360336 A1
(43) Pub. Date: Nov. 28, 2019

(54) METHOD FOR DYNAMIC WATER FEEDING AND HOLE SEALING USING HIGH WATER-ABSORBENT RESIN

(71) Applicant: CHINA UNIVERSITY OF MINING AND TECHNOLOGY, Jiangsu (CN)

(72) Inventors: Bai quan LIN, Jiangsu (CN); Wei YANG, Jiangsu (CN); Xinran HU, Jiangsu (CN)

(73) Assignee: CHINA UNIVERSITY OF MINING AND TECHNOLOGY, Jiangsu (CN)

(21) Appl. No.: 15/767,785

(22) PCT Filed: Jun. 26, 2017
(86) PCT No.: PCT/CN2017/089967

§ 371 Date: Apr. 12, 2018

(30) Foreign Application Priority Data
Feb. 13, 2017 (CN) 201710075821.5

(51) Int. Cl. E21F 15/00; E21B 33/138; E21F 15/08; C09K 8/44; C04B 26/16

(52) U.S. Cl. CPC E21F 15/005; E21B 33/138; E21F 7/00; C09K 8/44; C04B 26/16; E21F 15/08

(57) ABSTRACT

A method for dynamic water feeding and hole sealing using high water-absorbent resin is applicable to sealing of a borehole on which extraction has a great impact. Two ends of a hole-sealed section of the borehole are sealed. Fine mixed high water-absorbent resin powder wrapped in a piece of cotton cloth is disposed in the hole-sealed section of the borehole, a water injection pipe and a gas extraction pipe are inserted in the borehole, and an automatic feed water valve is used to inject water into the hole-sealed section. The fine mixed high water-absorbent resin powder that fills the hole-sealed section and surrounding cracks with the water flow rapidly swells up after soaking up water to fill the hole-sealed section, and maintains at a swelling pressure. After the powder swells up and hole sealing is completed, the extraction pipe is connected to an extraction apparatus to perform gas extraction. This method has advantages such as tight hole sealing, high automation degree, and dynamic hole sealing, thus effectively solving problems that pores around the borehole are poorly sealed, it is difficult to seal cracks newly produced by extraction and so on. Moreover, the powder for hole sealing is low in price, and therefore the hole sealing cost is low.

### BACKGROUND OF THE INVENTION

### Field of the Invention

The present invention relates to a method for dynamic water feeding and hole sealing using high water-absorbent resin, which is particularly applicable to hole sealing in an area in which a lot of cracks are formed and extraction greatly affects the hole sealing effect.

### Description of Related Art

Extraction is a basic solution to address a gas problem in a coal mine. The concentration of gas extracted through boreholes in coal mines in China is generally low, which reflects that the quality of borehole sealing is poor. At present, hole sealing processes are mainly as follows: hole sealing by injection of cement mortar, hole sealing using a foaming composite material such as polyurethane, and hole sealing with a hole packer. The hole sealing process using cement mortar aims to seal a tilted borehole. The cement mortar is brittle after it is solidified, and therefore it easily breaks to produce cracks. The hole sealing process using a foaming polymer material is high in costs and operation requirements, and has toxicity of a certain degree. A hole packer is usually used for hole sealing in a rock lane and is high in costs. The foregoing hole sealing processes all implement hole sealing by filling a borehole with a solid substance, but fail to effectively fill small cracks around the borehole. Moreover, the substance is solidified and coagulated after hole sealing is completed, thus failing to deal with cracks newly produced as the extraction proceeds.

### SUMMARY OF THE INVENTION

Technical problem: An objective of the present invention is to eliminate defects in the prior art, and provide a low-cost method for effectively sealing cracks around a borehole and cracks newly produced by extraction.

Technical solution: A method for dynamic water feeding and hole sealing using high water-absorbent resin of the present invention includes the following steps:

a. winding a polyurethane material tape A for sealing a borehole around a front end of a drainage pipe;

b. wrapping fine mixed high water-absorbent resin powder in a piece of cotton cloth, and winding the cotton cloth strip in which the fine mixed high water-absorbent resin powder is wrapped around a portion of the drainage pipe behind the polyurethane material tape A;

c. winding a polyurethane material tape B for sealing the borehole around a portion of the drainage pipe behind the cotton cloth strip in which the fine mixed high water-absorbent resin powder is wrapped, and simultaneously winding the polyurethane material tape B around a water inlet section of a water injection pipe, such that an inlet end of the water injection pipe is located between the polyurethane material tape A and the polyurethane material tape B; rapidly inserting the drainage pipe to a specified position in the borehole; and forming a hole-sealed section after the polyurethane foams and solidifies;

d. mounting an automatic feed water valve on the water injection pipe and setting a pressure, and connecting the valve to a downhole water-supply pipe;

e. turning on the automatic feed water valve to start injecting water into the formed hole-sealed section at the set pressure;

f. unfolding the cotton cloth by the fine mixed high water-absorbent resin powder in the cotton cloth wound around the drainage pipe under the effect of water, such that the powder comes into the hole-sealed section and enters cracks with the water flow to fully seal the cracks and isolate gas leakage channels; the fine mixed high water-absorbent resin powder rapidly swells up after soaking up water to fill the hole-sealed section, and tightly presses against the cracks around the borehole under its swelling pressure;

g. automatically stopping water injection when the water injection pressure reaches a set value;

h. connecting the drainage pipe to an extraction pipe network according to conventional techniques, to perform gas extraction; and

i. when the water injection pressure approaches zero, automatically starting water feeding by using the automatic feed water valve, such that the fine high water-absorbent resin powder maintains a water-swelling state, thus achieving a desirable hole sealing effect.

The high water-absorbent resin powder is formed by a mixture of high water-absorbent resin powder of the following five types: H30-60, H700, H30-50, H100 and H610, the granularity of the high water-absorbent resin powder ranges from 30 meshes to 100 meshes, and the water absorbency thereof ranges from 200 to 700 times.

The pressure of the automatic feed water valve is set according to the length of the hole-sealed section and a cracking degree of the borehole at the scene of a coal mine.

Beneficial effects: In the present invention, a water-swelling material is added to a hole-sealed section, thus effectively sealing initial cracks around a borehole. After water is injected into the hole-sealed section, fine mixed high water-absorbent resin powder soaks up water and rapidly swells up to fill the hole-sealed section, and the powder tightly presses against the cracks around the borehole under its swelling pressure. The fine powder enters the cracks, fully seals the cracks after soaking up water and swelling up, and isolates gas leakage channels. Generally, when a solid material is used to seal a hole, the hole sealing material breaks if a stress impacts the borehole, and cracks and gas leakage channels are produced, which greatly affect the hole sealing effect. The water-swelling material of the present invention has a stronger ability to cope with the impact. No cracks are produced, and a more desirable hole sealing effect is achieved. After extraction is performed for a period of time, new cracks and gas leakage channels are produced because the stress around the borehole changes. The powder soaks up water and turns into slurry of a state between a fluid and a solid. The slurry is sucked up into the newly produced cracks to seal the cracks under a negative pressure generated by extraction. The pressure in the borehole drops and the automatic feed water valve is turned on to inject water. Powder that does not fully take in water in the borehole soaks up water and swells up to fill the borehole again, such that the hole is sealed dynamically. Compared with the conventional hole sealing processes, this method is a dynamic hole sealing method capable of effectively sealing newly produced cracks. Because the powder can soak up water and effectively lock in moisture, this method has a better water-retaining property than a conventional water sealing method. The coal mass may take in a certain amount of moisture from the water-swelling material in the borehole, and the water-swelling material loses moisture to a certain degree as time goes by. Consequently, the automatic feed water valve is mounted and is connected to the water injection pipe. When the powder loses moisture and its pressure drops, the valve is triggered to start water injection. The water-swelling material soaks up water and swells up again to fill the borehole, and then, the feed water valve is turned off. Therefore, an automatic water feeding effect is achieved. The method is simple and easy to operate, has a desirable hole sealing effect, and can effectively improve gas extraction. Therefore, the present invention is widely practical in this technical field.

### BRIEF DESCRIPTION OF THE DRAWINGS

FIG. 1 is a schematic diagram of hole sealing before water injection according to the present invention; and

FIG. 2 is a schematic diagram of automatic water feeding after hole sealing according to the present invention.

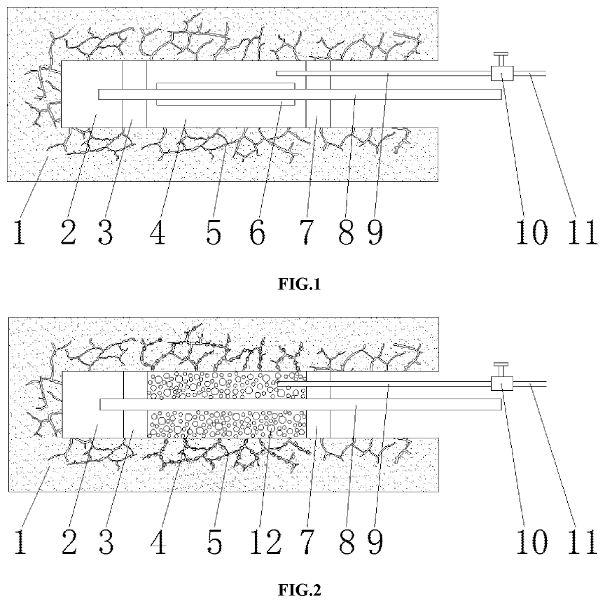

In the accompanying drawings: 1. Coal seam, 2. Borehole, 3. Polyurethane material tape A, 4. Hole-sealed section, 5. Cracks, 6. Cotton cloth strip, 7. Polyurethane material tape B, 8. Gas extraction pipe, 9. Water injection pipe, 10. Automatic feed water valve, 11. Downhole water-supply pipeline, and 12. Water-swelling mixed high water-absorbent resin powder.

### DETAILED DESCRIPTION OF THE EMBODIMENTS

An embodiment of the present invention is further described below with reference to the accompanying drawings.

A method for dynamic water feeding and hole sealing using high water-absorbent resin of the present invention specifically includes the following steps:

a. winding a polyurethane material tape A 3 for sealing a borehole 2 around a front end of a drainage pipe 8, where a portion of a sufficient length is left in front of the polyurethane material tape A 3, and the length is determined according to the actual situation of the borehole 2;

b. wrapping fine mixed high water-absorbent resin powder in a piece of cotton cloth, and winding the cotton cloth strip 6 in which the fine mixed high water-absorbent resin powder is wrapped around a portion of the drainage pipe 8 behind the polyurethane material tape A 3, where the cotton cloth is folded in half twice to wrap the powder and then spirally wound around the drainage pipe 8, two ends of the cotton cloth being tucked into the middle part thereof to avoid leakage of the powder; the high water-absorbent resin powder is formed by a mixture of high water-absorbent resin powder of the following five types: H30-60, H700, H30-50, H100 and H610, the granularity of the high water-absorbent resin powder ranges from 30 meshes to 100 meshes, and the water absorbency thereof ranges from 200 to 700 times;

c. spirally winding a polyurethane material tape B 7 for sealing the borehole 2 around a portion of the drainage pipe 8 behind the cotton cloth strip 6 in which the fine mixed high water-absorbent resin powder is wrapped, and simultaneously winding the polyurethane material tape B around a water inlet section of a water injection pipe 9, such that an inlet end of the water injection pipe 9 is located between the polyurethane material tape A 3 and the polyurethane material tape B 7, the distance between the polyurethane material tape A 3 and the polyurethane material tape B 7 being determined according to a state-stipulated standard length of a hole-sealed section; rapidly inserting the drainage pipe 8 to a specified position in the borehole 2; and forming a hole-sealed section 4 after the polyurethane foams and solidifies;

d. mounting an automatic feed water valve 10 on the water injection pipe 9 and setting a pressure, and connecting the valve to a downhole water-supply pipe 11;

e. turning on the automatic feed water valve 10 to start injecting water into the formed hole-sealed section 4 at the set pressure;

f. unfolding the cotton cloth by the fine mixed high water-absorbent resin powder in the cotton cloth wound around the drainage pipe 8 under the effect of water, such that the powder comes into the hole-sealed section and enters cracks 5 with the water flow to fully seal the cracks and isolate gas leakage channels; the fine mixed high water-absorbent resin powder rapidly swells up after soaking up water to fill the hole-sealed section, and tightly presses against the cracks around the borehole under the swelling pressure of the water-swelling mixed high water-absorbent resin powder 12;

g. automatically stopping water injection by the automatic feed water valve 10 when the water injection pressure reaches a set value;

h. connecting the drainage pipe 8 to an extraction pipe network according to conventional techniques, to perform gas extraction;

i. when the water injection pressure approaches zero, automatically starting water feeding by using the automatic feed water valve 10, such that the fine high water-absorbent resin powder maintains a water-swelling state, thus achieving a desirable hole sealing effect.

The pressure of the automatic feed water valve 10 is set according to the length of the hole-sealed section 4 and a cracking degree of the borehole at the scene of a coal mine, thereby achieving a desirable hole sealing effect. The pressure of the water injection pipe 9 is set according to measurement data. The pressure of the water injection pipe 9 and that of the hole-sealed section 4 are stabilized at set values in spite of the water pressure in the downhole water-supply pipe 11, thereby achieving an automatic water feeding effect.

What is claimed is:

1. A method for dynamic water feeding and hole sealing using high water-absorbent resin, comprising the following steps:
a. winding a polyurethane material tape A (3) for sealing a borehole (2) around a front end of a drainage pipe (8);
b. wrapping fine mixed high water-absorbent resin powder in a piece of cotton cloth, and winding the cotton cloth strip (6) in which the fine mixed high water-absorbent resin powder is wrapped around a portion of the drainage pipe (8) behind the polyurethane material tape A (3);
c. winding a polyurethane material tape B (7) for sealing the borehole (2) around a portion of the drainage pipe (8) behind the cotton cloth strip (6) in which the fine mixed high water-absorbent resin powder is wrapped, and simultaneously winding the polyurethane material tape B around a water inlet section of a water injection pipe (9), such that an inlet end of the water injection pipe (9) is located between the polyurethane material tape A (3) and the polyurethane material tape B (7); rapidly inserting the drainage pipe (8) to a specified position in the borehole (2); and forming a hole-sealed section (4) after the polyurethane foams and solidifies;
d. mounting an automatic feed water valve (10) on the water injection pipe (9) and setting a pressure, and connecting the valve to a downhole water-supply pipe (11);
e. turning on the automatic feed water valve (10) to start injecting water into the formed hole-sealed section (4) at the set pressure;
f. unfolding the cotton cloth by the fine mixed high water-absorbent resin powder in the cotton cloth wound around the drainage pipe (8) under the effect of water, such that the powder comes into the hole-sealed section and enters cracks (5) with the water flow to fully seal the cracks and isolate gas leakage channels; the fine mixed high water-absorbent resin powder rapidly swells up after soaking up water to fill the hole-sealed section, and tightly presses against the cracks around the borehole under its swelling pressure;
g. automatically stopping water injection when the water injection pressure reaches a set value;
h. connecting the drainage pipe (8) to an extraction pipe network according to conventional techniques, to perform gas extraction; and
i. when the water injection pressure approaches zero, automatically starting water feeding by using the automatic feed water valve (10), such that the fine high water-absorbent resin powder maintains a water-swelling state, thus achieving a desirable hole sealing effect.

2. The method for dynamic water feeding and hole sealing using high water-absorbent resin according to claim 1, wherein the high water-absorbent resin powder is formed by a mixture of high water-absorbent resin powder of the following five types: H30-60, H700, H30-50, H100 and H610, the granularity of the high water-absorbent resin powder ranges from 30 meshes to 100 meshes, and the water absorbency thereof ranges from 200 to 700 times.

3. The method for dynamic water feeding and hole sealing using high water-absorbent resin according to claim 1, wherein the pressure of the automatic feed water valve (10) is set according to the length of the hole-sealed section (4) and a cracking degree of the borehole at the scene of a coal mine.
